(19) United States
(12) Patent Application Publication
(10) Pub. No.: US 2015/0312653 A1
(43) Pub. Date: Oct. 29, 2015

(54) CONTEXT DETERMINATION USING CONTAINER SENSORS

(71) Applicants: Daniel Avrahami, Mountain View, CA (US); Anthony G. Lamarca, Seattle, WA (US)

(72) Inventors: Daniel Avrahami, Mountain View, CA (US); Anthony G. Lamarca, Seattle, WA (US)

(21) Appl. No.: 14/263,213

(22) Filed: Apr. 28, 2014

(51) Int. Cl. H04Q 9/00

(52) U.S. Cl. CPC H04Q 9/00

(57) ABSTRACT

Technologies for determining a context of a reusable container are disclosed. The reusable container includes a container sensor coupled thereto. The container sensor generates sensor data indicative of a context of the reusable container and transmits the sensor data to a separate computing device. The container sensor may be attached to various portions of the reusable container, such as a carrying strap, clasp, latch, and/or enclosure wall. In some embodiments, the container sensor is embodied as a low-power sensor to periodically or responsively transmit the sensor data. The sensor data may be analyzed by the separate computing device to determine the context of the reusable container and/or a context of a user of the reusable container. A security event may also be detected based on the sensor data.

### BACKGROUND

Sensors and other monitoring devices are becoming a common companion in the everyday life of many people. In fact, many of the electrical devices utilized on a daily basis by an individual include multiple sensors. For example, many mobile computing devices, such as smartphones and tablet computers, include a plethora of sensors. Sensors are also commonly used in static electronic devices, such as consumer electronics (e.g., a “smart” televisions), access security systems, and other immobile electronic devices. Additionally, in a more recent trend, sensors have been added to wearable personal items such as “smart” clothing, watches, and other jewelry and wearable personal items.

Depending on the type of sensor and the device or item in which it is included, a sensor may be configured to monitor various stimuli and generate sensor data indicative of various characteristics. For example, the sensors included in many mobile computing devices are oftentimes configured to generate sensor data indicative of various context parameters of the mobile computing device itself, such as the current location of the computing device, characteristics of the current environment of the mobile computing device, and/or other context parameters related to the mobile computing device. Alternatively, sensors included in wearable personal items are oftentimes configured to generate sensor data indicative of a context parameter of the wearer such as, the wearer's heart rate or activity level.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for determining context of a reusable container and/or a user of the reusable container;

FIG. 2 is a simplified illustration of at least one embodiment of the reusable container of FIG. 1;

FIG. 3 is a simplified illustration of at least one embodiment of an environment of a computing device of the system of FIG. 1;

FIG. 4 is a simplified flow chart of at least one embodiment of a method for generating sensor data that may be executed by a container sensor of the reusable container of FIG. 1;

FIG. 5 is a simplified flow chart of at least one embodiment of a method for generating power that may be executed by a container sensor of the reusable container of FIG. 1; and

FIGS. 6 and 7 are simplified flow diagrams of at least one embodiment of a method for analyzing sensor data that may be executed by a computing device of the system of FIG. 1.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

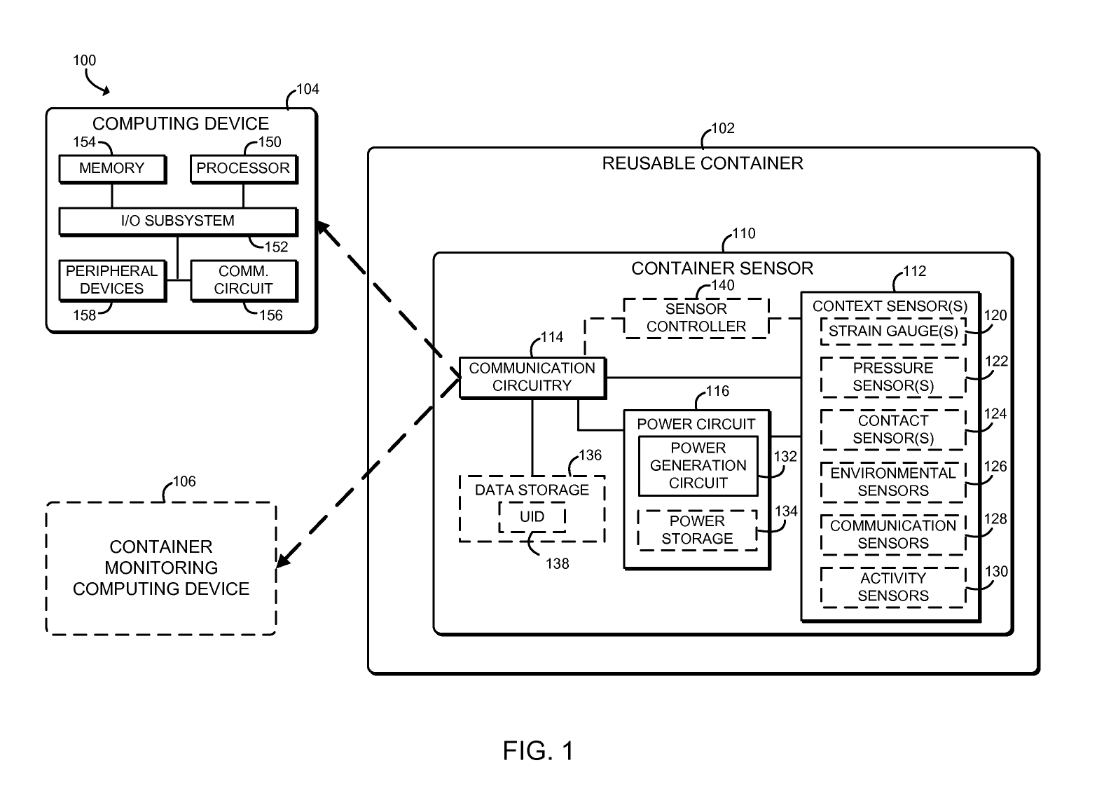

Referring now to FIG. 1, in the illustrative embodiment, a system 100 for determining a context of a container includes a reusable container 102 and a computing device 104. As discussed in more detail below, the reusable container 102 may be embodied as any type of general-purpose or special-purpose reusable container to hold items of a user, such as a gym bag, purse, or shopping bag. The reusable container 102 includes one or more container sensors 110 to sense characteristics or parameters of the reusable container 102 and/or its environment. The container sensor 110 may be attached to, incorporated in, or otherwise embedded in various portions of the reusable container 102 such as, for example, a carrying strap, a clasp, a latch, or a wall of an enclosure of the reusable container. In use, the container sensor 110 generates sensor data indicative of a context of the reusable container and periodically, occasionally, or responsively transmits the sensor data. Depending on the particular type of container sensor 110, the sensor data may be indicative of any type of context of the reusable container 102 including, but not limited to, sensor data indicative of whether the reusable container is currently being carried (e.g., by a single or by multiple carrying straps) or otherwise in motion, the weight or presence of items held in the reusable container, whether an item has been added to or removed from the reusable container, sensed signals (e.g., signal strength), and/or various environmental characteristics of the current environment of the reusable container (e.g., temperature, altitude, light, presence of particular gasses or chemicals, etc.), and/or other context parameters.

As discussed above, the container sensor 110 may periodically, occasionally, or responsively transmit the generated sensor data. For example, the container sensor 110 may broadcast the sensor data at defined intervals or in response to an interrogation signal transmitted by the computing device 104. The sensor data is received by the computing device 104, which may analyze the sensor data to determine the context of the reusable container 102 and/or a context of a user of the container 102. For example, the computing device 104 may determine any of the reusable container context parameters mentioned above based on the received sensor data and/or an aggregate of received sensor data over a time period. Additionally or alternatively, the computing device 104 may determine, or otherwise infer, context parameters of a user of the reusable container 102 based on the received sensor data. For example, the computing device 104 may determine whether the user is in motion (e.g., walking) or an activity being performed by the user (e.g., the user is carrying the reusable container 102, shopping, accessing the reusable container, etc.). In some embodiments, the computing device 104 may monitor the user's interactivity with the reusable container 102 over a period of time (e.g., how often the reusable container 102 is opened/closed, how many items are being held by the reusable container 102, the average weight of the items held by the reusable container 102, etc.). Additionally, as discussed in more detail below, the computing device 104 may determine whether a security event has occurred based on the sensor data and/or determined context of the reusable container 102 and/or user of the reusable container 102. For example, the computing device 104 may monitor a location of the user and interactivity of reusable container 102 (e.g., is the reusable container being opened and/or items removed) to thereby determine whether the reusable container 102 is being accessed in an unauthorized manner.

The container sensor 110 may be embodied as, or otherwise include, any type of low-power sensor capable of being embedded in, incorporated into, or otherwise attached to the reusable container 102. In the illustrative embodiment, the container sensor 110 includes one or more context sensors 112, communication circuitry 114, and a power circuit 116 as shown in FIG. 1. The context sensor(s) 112 may be embodied as any type of sensor capable of sensing and generating data indicative of a context of the reusable container 102. For example, the context sensor(s) 112 may include one or more strain gauges 120, one or more pressure sensors 122, one or more contact sensors 124, one or more communication sensors 128, one or more activity sensors 130, and/or one or more other sensors capable of sensing a context parameter of the reusable container 102.

The strain gauge sensor(s) 120 may be embodied as any type of sensor capable of sensing an amount of strain applied to the reusable container 102. For example, in some embodiments, a strain gauge sensor 120 may be attached to a carrying strap of the reusable container 102 to sense a context of the reusable container 102, such as whether the carrying strap is in a tensed state or a relaxed state. If the carrying strap is determined to be tensed, such context information may be indicative that the reusable container 102 is being carried (e.g., on a shoulder) or hanging (e.g., on a chair or hook). If the carrying strap is determined to be relaxed, such context information may be indicative that the reusable container 102 is at a rest state (e.g., setting on a table).

The pressure sensor(s) 122 may be embodied as any type of sensor capable of sensing an amount of pressure applied to the reusable container 102. For example, in some embodiments, a pressure sensor 122 may be attached to a bottom or side wall of an enclosure of the reusable container 102 to sense the presence of items in the reusable container (e.g., the addition or removal of items). The contact sensor(s) 124 may be embodied as any type of sensor capable of sensing a formation, or breaking thereof, of a connection between two components. For example, in some embodiments, a contact sensor 124 may be attached to a latch of an enclosure of the reusable container 102 to sense whether the latch is opened and/or closed. The environmental sensor(s) 126 may be embodied as any type of sensor capable of sensing a characteristic of the local environment of the reusable container 102. For example, the environmental sensor 126 may be embodied as a temperature sensor, a light sensor, an altitude sensor, a gas sensor, or other sensor capable of measuring characteristics of the local environment. The communication sensor(s) 128 may be embodied as any type of sensor capable of sensing communications received by the container sensor 110. For example, the communication sensor 128 may be embodied as a signal strength sensor configured to sense the signal strength of one or more received communications. The activity sensor(s) 130 may be embodied as any type of sensor capable of sensing characteristics or parameters indicative of an activity being performed by a user of the reusable container 102. For example, the activity sensor 130 may be embodied as a motion sensor, a location sensor, an accelerometer, a gyroscope sensor, or other sensor configured to sense various characteristics or parameters useful in determining an activity of a user of the reusable container 102.

It should be appreciated that the container sensor 110 may include a single context sensor 112 or include multiple context sensors 112 of the same or different type. Additionally, the reusable container 102 may include a single container sensor 110 or multiple container sensors 110, each including similar or dissimilar context sensors 112.

The communication circuitry 114 of the container sensor 110 may be embodied as any type of communication circuit, device, or collection thereof, capable of transmitting the sensor data generated by the context sensors 112. In the illustrative embodiment, the container sensor 110 is embodied as a low-power sensor and, as such, is configured only to transmit sensor data. As such, the communication circuitry 114 may be embodied as a transmitter. Of course, in other embodiments, the container sensor 110 may also be configured to receive communications (e.g., an interrogation signal) and, as such, the communication circuitry 114 may be embodied as a transceiver in such embodiments.

As discussed above, the container sensor 110 may transmit the generated sensor data periodically, occasionally, or responsively. For example, in the illustrative embodiment, the communication circuitry 114 is configured to periodically broadcast the sensor data. The rate and/or signal strength of such broadcast communications may be dependent on the amount of power available via the power circuit 116 (e.g., the rate of transmission may be decreased as the amount of available power decreases). In other embodiments, the communication circuitry 114 may broadcast or otherwise transmit the sensor data in response to an interrogation signal (e.g., a signal received from the computing device 104). The communication circuitry 114 may use any suitable communication protocol or technology to transmit the sensor data including, but not limited to, the ANT+communication protocol, the Bluetooth Low Energy (BTLE) communication protocol, or other communication protocol.

The power circuit 116 may be embodied as any power circuit or device capable of providing power to the container sensor 110. As discussed above, the container sensor 110 is configured as a low-power or ultra-low-power sensing device. For example, in the illustrative embodiment, the container sensor 110 is configured to utilize no more than 10 microwatts of power. As such, the power circuit 116 may be embodied as a low-power circuit. In the illustrative embodiment, the power circuit 116 is embodied as, or otherwise includes, a power generation circuit 132 to generate power for use by the other components of the container sensor 110. The power generation circuit 132 may be embodied as any type of power generation device or circuitry. In the illustrative embodiment, the power generation circuit 132 is embodied as a circuit that generates power in response to motion of the reusable container 102 such as, for example, a piezoelectric circuit. Of course, it should be appreciated that the available power from such power generation circuitry may be limited to times of active motion or movement of the reusable container 102. As such, the rate or frequency of transmissions of the sensor data by the container sensor 110 may be based on the available power generated by the power generation circuit 132 such that the rate of sensor data transmissions is proportional to the power generated (i.e., the rate of transmissions may decrease as the available power decreases).

In some embodiments, the power generation circuit 132 may include a backup power generation circuit to reduce or alleviate the fluctuations in transmission rate, e.g., during those times in which the reusable container 102 is not in motion. Such a backup power generation circuit may be embodied as any type of power generation circuit that generates power in a manner different from the primary power generation circuit 132. For example, in some embodiments, the power generation circuit 132 may include a photovoltaic power generation circuit to generate power based on an amount of received light. Additionally, in some embodiments, the power circuit 116 may further include a power storage 134, such as a battery. The power storage 134 may be rechargeable or non-rechargeable. In those embodiments in which the power storage 134 is rechargeable, the power generation circuit 132 may be configured to recharge the power storage 134, which may be subsequently used to power the components of the container sensor 110 (e.g., to reduce the transmission rate fluctuations of the container sensor 110).

In some embodiments, the container sensor 110 may also include a data storage 136. The data storage 136 may be embodied as any type of volatile or non-volatile memory or other data storage capable of storing various data, such as the sensor data generated by the context sensors 112. For example, in some embodiments, the container sensor 110 may be configured to store sensor data generated by the context sensors 112 and transmit the stored data at a later time. Additionally, in some embodiments, a unique identifier 138 may be stored in the data storage 136. The unique identifier 138 uniquely identifies the container sensor 110 from other container sensors 110 and/or other devices. In use, the container sensor 110 may be configured to transmit the unique identifier 138 with the sensor data such that the origination of the sensor data may be determined (e.g., by the computing device 104).

As discussed above, the container sensor 110 is embodied as a low-power, low functionality sensor device in the illustrative embodiment. However, in some embodiments, the container sensor 110 may include additional functionality (e.g., the ability to locally analyze sensor data). In such embodiments, the container sensor 110 may include a sensor controller 140. The sensor controller 140 may be embodied as any type of circuit or device capable of controlling the functions of the other devices of the container sensor 110. For example, the sensor controller 140 may be embodied as a processor, microcontroller, digital signal processor, or other processor or processing/controlling circuit. In embodiments in which the container sensor 110 includes the sensor controller 140, the sensor controller 140 may be configured to analyze the sensor data generated by the context sensors 112 to determine a context of the reusable container 102 and/or a user of the reusable container 102 and transmit data the determined context via the communication circuitry 114. That is, in such embodiments, the sensor controller 140 may perform some pre-processing of the sensor data and/or perform the functions of the computing device 104 described below.

The computing device 104 may be embodied as any type of computing device capable of receiving the sensor data from the container sensor 110 and performing the functions described herein. For example, the computing device 104 may be embodied as a smartphone, a cellular phone, a tablet computer, a notebook computer, a laptop computer, a desktop computer, a smart watch, a wearable computing device, a distributed computing system, a multiprocessor system, a consumer electronic device, a smart appliance, and/or any other computer or electronic device. As shown in FIG. 1, the illustrative computing device 104 includes a processor 150, an I/O subsystem 152, memory 154 and a communication circuit 156. Of course, the computing device 104 may include other or additional components, such as those commonly found in a portable computer (e.g., various input/output devices), in other embodiments. Additionally, in some embodiments, one or more of the illustrative components may be incorporated in, or otherwise form a portion of, another component. For example, the memory 154, or portions thereof, may be incorporated in the processor 150 in some embodiments.

The processor 150 may be embodied as any type of processor capable of performing the functions described herein. For example, the processor may be embodied as a single or multi-core processor(s), digital signal processor, microcontroller, or other processor or processing/controlling circuit. Similarly, the memory 154 may be embodied as any type of volatile or non-volatile memory or data storage capable of performing the functions described herein. In operation, the memory 154 may store various data and software used during operation of the computing device 104 such as operating systems, applications, programs, libraries, and drivers. The memory 154 is communicatively coupled to the processor 150 via the I/O subsystem 152, which may be embodied as circuitry and/or components to facilitate input/output operations with the processor 150, the memory 152, and other components of the computing device 104. For example, the I/O subsystem 152 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 152 may form a portion of a system-on-a-chip (SoC) and be incorporated, along with the processor 150, the memory 154, and other components of the computing device 104, on a single integrated circuit chip.

The communication circuitry 156 of the computing device 104 may be embodied as any communication circuit, device, or collection thereof, capable of receiving the sensor data transmitted by the container sensor 110. Depending on the particular type of communication modalities utilized by the communication circuitry 114 of the container sensor 110, the communication circuit 156 may utilize any suitable communication protocol and related technology. In some embodiments, the communication circuit 156 may be configured to transmit an interrogation signal to the container sensor 110 to promote the container sensor 110 to transmit the sensor data.

The computing device 104 may also include one or more peripheral devices 158 in some embodiments. Such peripheral devices 158 may include any type of peripheral device commonly found in a typical computer device, such as various input/output devices. For example, in some embodiments, the computing device 104 includes a display, keyboard, mouse, and/or other input/output device.

In some embodiments, as discussed above, the computing device 104 may be embodied as a personal computing device 104 such as a smartphone or tablet computer, which may be operated by a user of the reusable container 102. However, in other embodiments, the system 100 may also include a container monitoring computing device 106, which may perform functions similar to those described above and below with regard to the computing device 104. The container monitoring computing device 106 may be embodied as any type of computer device capable of monitoring sensor data received form the container sensor 110. For example, in some embodiments, the container monitoring computing device 106 may be embodied as a store computing device located in a shopping store and configured to monitor the shopping activity of a user of the reusable container (which may be provided by the store for shopper's use). As such, it should be appreciated that the functionality of the computing device 104, which is described in more depth below, additionally or alternatively may be performed by the container monitor computing device 106 and/or other static monitoring systems. The container monitoring computing device 106 may include components similar to the components of the computing device 104, such as the processor 150, the I/O subsystem 152, and the memory 154, the description of which is applicable to the corresponding components of the container monitoring computing device 106 and is not repeated herein so as not to obscure the present disclosure.

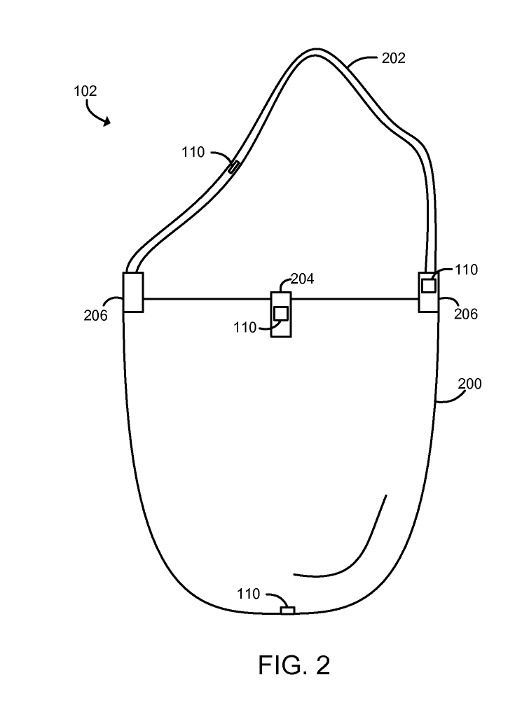

Referring now to FIG. 2, as discussed above, the reusable container 102 may be embodied as any type of general-purpose or special-purpose reusable container to hold items of a user. For example, the reusable container 102 may be embodied as a gym or athletic bag, a purse, a shopping bag, a backpack, a bowling bag, a bucket bag, a clutch, a cosmetic case, a duffel bag, luggage, a messenger bag, a saddle bag, a satchel, a tote bag, or other container capable of holding items of a user. For example, in the illustrative embodiment of FIG. 2, the reusable container 102 is embodied as a shopping bag, purse, or other personal bag and includes an openable enclosure 200 and one or more carrying straps 202 (e.g., handles, shoulder straps, etc.). The openable enclosure 200 includes an interior chamber or pocket to hold items placed therein and a latch 204 to selectively secure or lock the openable enclosure 200 in a closed position or state. Each of the straps 202 is secured to the openable enclosure 200 via a corresponding clasp 206. Of course, the reusable container 102 may have other structures and features in other embodiments based on, for example, the type of container or intended use of the reusable container 102.

As discussed above, the reusable container 102 includes one or more container sensors 110 attached thereto. Depending on the type of container sensor 110 and the desired context data to be sensed, the container sensor 110 may be attached to, embedded in, or otherwise incorporated into any suitable portion of the reusable container 102. For example, as shown in FIG. 2, a container sensor 110 may be embedded in or attached to one or more of the carrying straps 202 and/or in one or more of the clasps 206. In such embodiments, the container sensor 110 may be embodied as, or otherwise include, a strain gauge 120 to measure strain applied to the carrying strap 202 and/or the clasp 206 to generate sensor data indicative of whether the reusable container 102 is being carried (or, more specifically, whether the reusable container 102 is being carried via one or two carrying straps 202). Additionally or alternatively, a container sensor 110 may be embedded in or attached to the openable enclosure 200. For example, the container sensor 110 may be embodied as, or otherwise include, a pressure sensor 122 embedded in a bottom or side enclosure wall of the openable enclosure 200 to measure the presence and/or weight of items held in the openable enclosure 200. Additionally or alternatively, a container sensor 110 may be embedded in or attached to the latch 204. For example, the container sensor 110 may be embodied as, or otherwise include, a contact sensor 124 embedded in the latch 204 to sense whether the latch is opened or closed.

Of course, the container sensors 110 attached to or embedded in the carrying straps 202, the openable enclosure 200, and/or the latch 204 may be embodied as or otherwise include other types of sensors than those illustratively described above in other embodiments. Additionally, reusable container 102 may include additional or fewer container sensors 110, which may be attached to or embedded in other portions of the reusable container 102 in other embodiments.

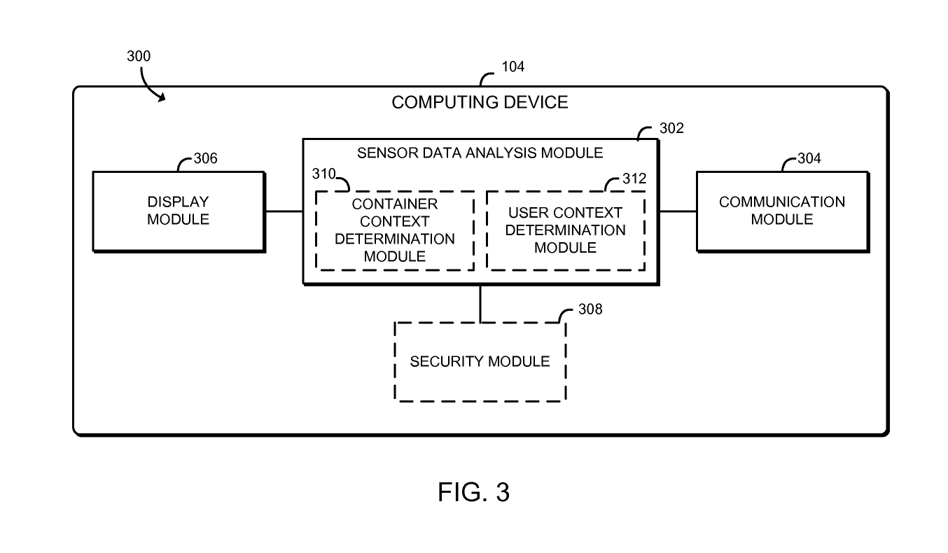

Referring now to FIG. 3, in use, the computing device 104 (and/or the container monitoring computing device 106) establishes an environment 300. The illustrative environment 300 includes a sensor data analysis module 302, a communication module 304, and a display module 306. Additionally, in some embodiments, the environment 300 may further include a security module 308. Each of the sensor data analysis module 302, the communication module 304, the display module 306, the security module 308, and other modules of the environment 300 may be embodied as software, firmware, hardware, or any combination thereof.

The sensor data analysis module 302 analyzes the sensor data received from the container sensor 110 via the communication module 304 to determine a context of the reusable container 102 and/or a context of the user of the reusable container 102. As such, the sensor data analysis module 302 may include a container context determination module 310 and/or a user context determination module 312. The container context determination module 310 is configured to analyze the sensor data to determine one or more context parameters of the reusable container 102. To do so, the container context determination module 310 may analyze individual sensor data received from a single container sensor 110 or analyze an aggregation of sensor data from multiple container sensors 110 and/or collected over a time period. Depending on the particular type of sensor data received, the container context determination module 310 may determine any type of context parameter or characteristic of the reusable container 102. For example, in some embodiments, the container context determination module 310 may determine whether the reusable container 102 is currently being carried, how the reusable container 102 is being carried (e.g., by one or two carrying straps), whether the reusable container 102 is in motion and qualities of such motion (e.g., gate rate), the weight or presence of items held in the reusable container 102, whether an item has been added to or removed from the reusable container 102, sensed signals (e.g., signal strength), and/or various environmental characteristics of the current environment of the reusable container 102 (e.g., temperature, altitude, light, presence of particular gasses or chemicals, etc.), and/or other context parameters. The container context determination module 310 may display the determined context or related data of the reusable container 102 on a display of the computing device via the display module 306.

The user context determination module 312 is configured to analyze the received and/or aggregated sensor data and/or the determined context of the reusable container 102 to determine or infer a context of the user of the reusable container 102. For example, the user context determination module 312 may determine whether the user is in motion and/or qualities of such motion (e.g., walking, running, etc.) based on a pattern of the sensor data (e.g., the cyclic tension rate of a strain gauge 120). Additionally, the user context determination module 312 may determine an activity being performed by the user of the reusable container 102. For example, the user context determination module 312 may determine whether the user is carrying the reusable container 102, whether the user is actively shopping, whether the user is actively accessing or opening the reusable container 102, etc. The determination of the user's activity may be based on the user's interactivity with the reusable container 102. For example, the user context determination module 312 may monitor the frequencies or pattern at which the reusable container 102 is opened or closed, items are added to or removed from the reusable container 102, the number of items added or removed, the total or average weight of items held by the reusable container 102, and/or other user interaction with the reusable container 102.

In some embodiments, the sensor data analysis module 302 may utilize additional sensor data or other data received from sensors and/or sources other than the container sensor 110 to determine a context of the reusable container 102 and/or the user of the reusable container 102. Such additional sensor data or other data may be used in conjunction with the sensor data received from the container sensor 110 to infer additional or more accurate context information. For example, the computing device 104 may include a location determination sensor (e.g., a global positioning system circuit) to determine a location of the computing device 104. In such embodiments, the sensor data analysis module 302 may determine the user is presently shopping based on a determination that the user's current location is at a store and a determination, based on the received sensor data, that the reusable container 102 is being repeatedly opened and items are being added to the reusable container 102. Of course, it should be appreciated that other user activity determinations may be performed based on a wide array of available sensor data and other data from the container sensor 110 and other sensors and data sources available to the computing device 104.

The security module 308 is configured to analyze the sensor data received from the container sensor 110 and/or the determined context of the reusable container 102 and/or the user of the reusable container 102 to determine whether a security event has occurred and notify a user of the computing device 104 of such an occurrence. Such security events may be embodied as any unauthorized interaction with the reusable container 102 based on the sensor data generated by the container sensor 110. For example, the security module 308 may alert (e.g., display a notification via the display module 306, generate an audible or tactile alert, etc.) the user of the computing device 104 every time the reusable container 102 is open or an item is removed from the reusable container 102. Such monitoring may be actively switched on or off by the user of the computing device 104.

In some embodiments, more complex analysis of the sensor data and other data may be utilized to determine the occurrence of a security event. For example, the security module 308 may determine an unauthorized interaction with the reusable container 102 is occurring based on sensor data from the container sensor 110 indicating that the reusable container 102 is being picked up or moved and the signal strength of such transmission of sensor data (i.e., how close the reusable container 102 is to the computing device 104). That is, if the security module 308 determines that the reusable container 102 is not near or in the vicinity of the computing device 104, the security module 308 may alert the user of the computing device 104 in response to an interaction of the reusable container 102 (e.g., opening or movement thereof). As another example, in embodiments in which the computing device 104 includes a location determination circuit, the security module 308 may utilize the determined location of the computing device 104, the sensor data received from the container sensor 110, and/or other data to determine whether a security event has occurred. For example, the security module 308 may determine that a security event has occurred if the current location is the user's home, the current time is nighttime, and the reusable container 102 has been opened or moved. Of course, it should be appreciated that the security module 308 may utilize any other useful data in conjunction with the sensor data, along with other security parameters, to determine the occurrence of a security event in other embodiments.

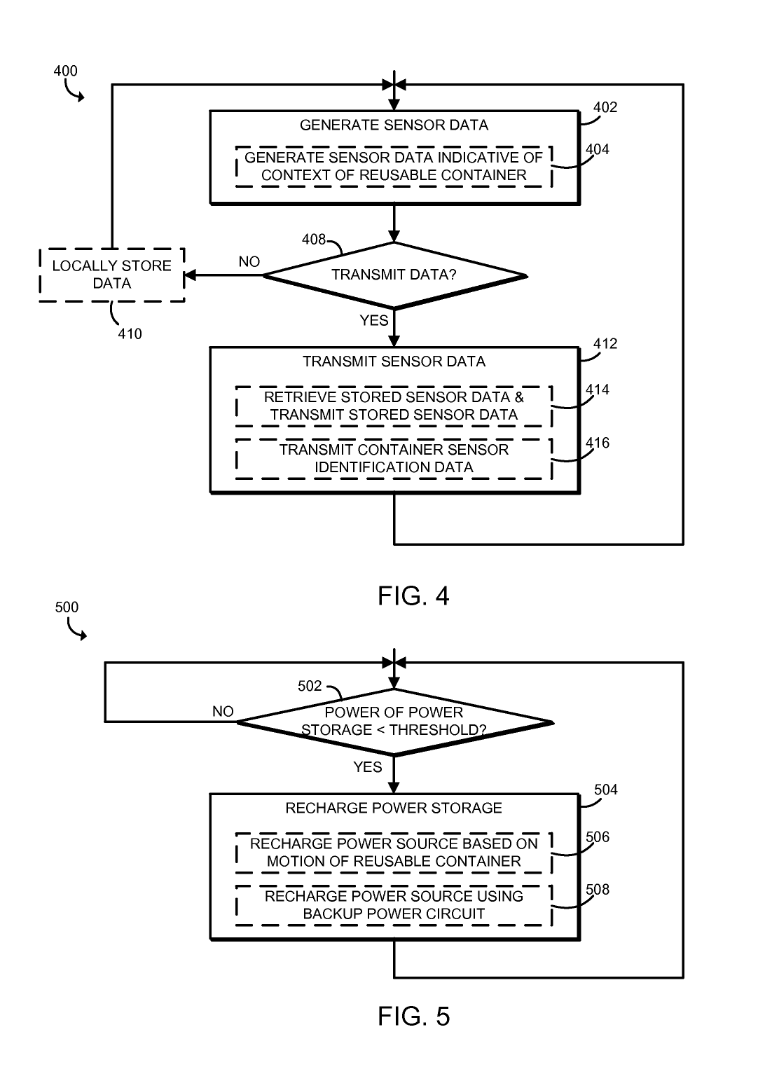

Referring now to FIG. 4, in use, the container sensor 110 may execute a method 400 for generating sensor data. The method 400 begins with block 402 in which the context sensor(s) 112 generate sensor data. For example, in block 404, the context sensor(s) 112 may generate sensor data indicative of a context of the reusable container 102. As discussed above, the particular type of sensor data generated in block 402 may be based on the particular type of context sensor(s) included in the container sensor 110. For example, the sensor data may be embodied as sensor data indicative of whether a carrying strap of the reusable container 102 is in a tensed or relaxed state (e.g., an amount of strain), an amount of pressure, the forming or breaking of a connection, various environmental characteristics such as temperature or gas presence, signal strength of a received signal, and/or other data useful in determining a context of the reusable container 102 as discussed above.

In block 408, the container sensor 110 determines whether to transmit the sensor data generated in block 402. As discussed above, the container sensor 110 may transmit the sensor data occasionally, periodically, or responsively. For example, in some embodiments, the container sensor 110 may be configured to periodically broadcast the sensor data. The periodicity of such transmissions may be predefined or based on the available power generated by the power circuit 116 as discussed above. For example, the container sensor 110 may only transmit sensor data when enough power is available for such transmissions (i.e., the rate of transmissions may be dependent on the currently generated power). Alternatively, in some embodiments, the container sensor 110 may transmit power in response to an interrogation signal or other signal prompting the container sensor 110 to transmit the sensor data.

If the container sensor 110 determines not to transmit the sensor data in block 408, the method 400 advances to block 410. In some embodiments, in block 410, the container sensor 110 may store the sensor data in the local data storage 136 in response to a determination not to transmit the data. In this way, the container sensor 110 may store sensor data over a time period and subsequently transmit an accumulation of sensor data later in time. Alternatively, in other embodiments, the container sensor 110 may not store the sensor data in block 410, in which case the un-transmitted sensor data may be ignored. Regardless, the method 400 subsequently loops back to block 402 in which the context sensor(s) 112 generate additional sensor data.

Referring back to block 408, if the container sensor 110 determines that the sensor data should be transmitted, the method 400 advances to block 412 in which the container sensor 110 transmits the sensor data. As discussed above, the container sensor 110 may transmit the sensor data by broadcasting the sensor data. In some embodiments, the container sensor 110 may transmit the sensor data as it is generated in real-time or near real-time. However, in embodiments in which sensor data is stored in the data storage 136, the container sensor 110 may retrieve the stored data from the data storage 136 and subsequently transmit the stored data in block 414. Additionally, in some embodiments, the container sensor 110 is configured to retrieve the unique identifier 138 stored in the data storage 136 and transmit the unique identifier 138, along with the sensor data, in block 416. After transmission of the sensor data (and the unique identifier in some embodiments), the method 400 loops back to block 402 in which the context sensor(s) 112 generate additional sensor data.

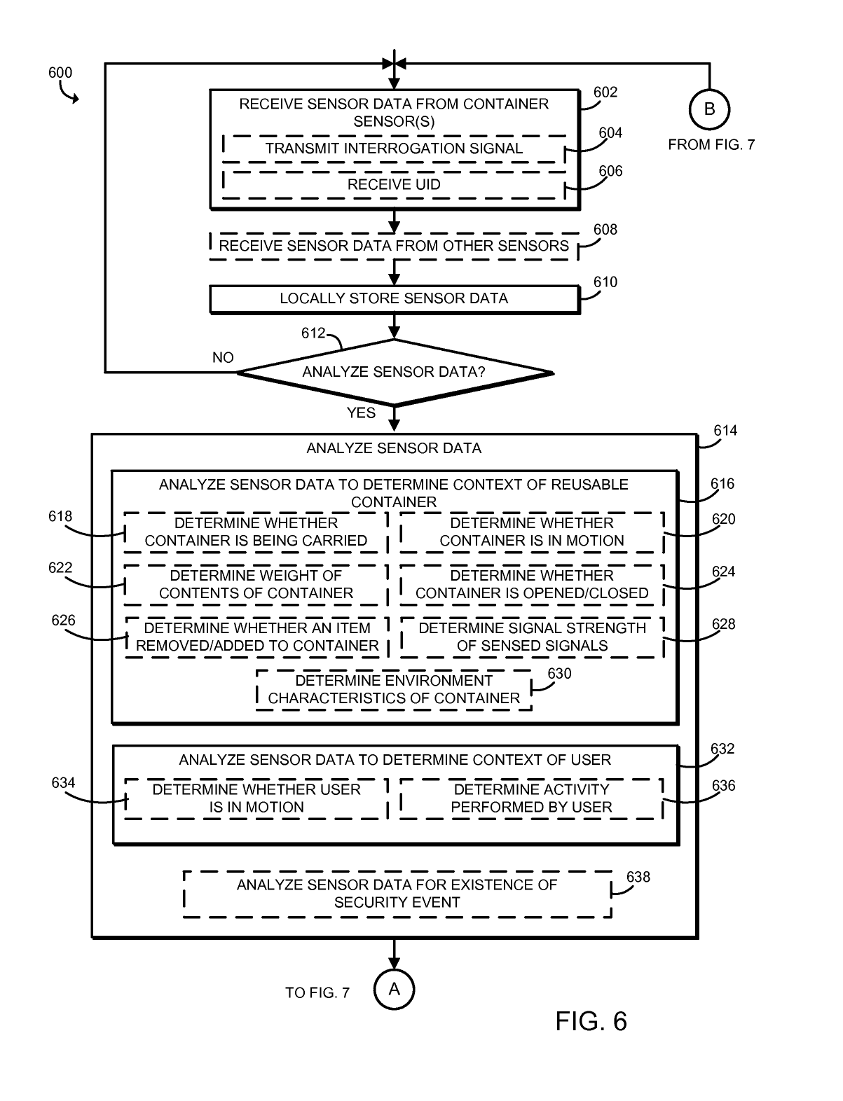

Referring now to FIG. 5, as discussed above, the power circuit 116 of the container sensor 110 may include a power generation circuit 132 and a power storage 134 in some embodiments. In such embodiments, the power circuit 116 of the container sensor 110 may execute a method 500 for generating power. The method 500 begins with block 502 in which the power circuit 116 determines whether the available power of the power storage 134 is less than a predefined threshold. If so, the method 500 advances to block 504 in which the power generation circuit 132 recharges the power storage 134. For example, as discussed above, the power generation circuit 132 may generate power in response to motion of the reusable container 102 and recharge the power storage 134 using the generated power in block 506. Additionally, in some embodiments, the power storage 134 may be recharged using a backup power circuit of the power generation circuit 132. For example, as discussed above, the power generation circuit 132 may include a photovoltaic power generation circuit to provide power in those circumstances in which the reusable container 102 is not in motion. After charging of the power storage 134, the method 500 loops back to block 502 in which the power circuit 116 again determines whether the available power of the power storage 134 is less than a predefined threshold.

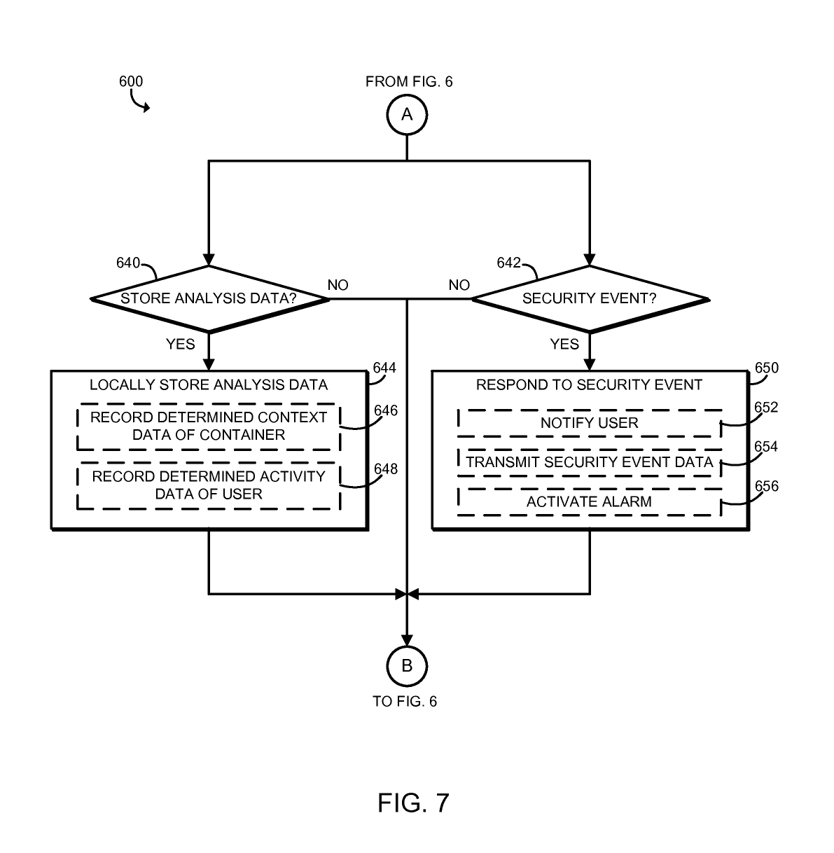

Referring now to FIGS. 6 and 7, in use, the computing device 104 (and/or the container monitoring computing device 106) may execute a method 600 for analyzing sensor data and determining a context of the reusable container 102. The method 600 begins with block 602 in which the computing device 104 receives the sensor data from the container sensor 110. Depending on the rate of the sensor data transmissions, the computing device 104 may occasionally or periodically receive the sensor data. For example, as discussed above, the computing device 104 may receive the sensor data in real-time or near real-time or receive an accumulation of sensor data in a single transmission. In some embodiments, the computing device 104 may transmit an interrogation signal in block 604 to prompt the container sensor 110 to transmit the sensor data. The interrogation signal may be embodied as any type of signal that signifies a request for the sensor data. In addition to the sensor data, the computing device 104 may receive the unique identifier 138 associated with the container sensor 110 in block 606. The unique identifier 138 allows the computing device 104 to associate sensor data with particular container sensors 110 (e.g., in those embodiments in which the reusable container 102 include multiple container sensors).

In some embodiments, the computing device 104 may also receive other sensor data from other sensors or sources in block 608. For example, as discussed above, the computing device 104 may include a location determination circuit configured to generate sensor data indicative of the location of the computing device 104. In such embodiments, the computing device 104 may utilize such other sensor data, in conjunction with the sensor data received from the container sensor 110 as discussed above. Regardless, in block 610, the computing device 104 stores the sensor data received in block 602, and any other sensor data, in a local storage (e.g., in memory 154).

In block 612, the computing device 104 determines whether the received sensor data should be analyzed. The computing device 104 may continually, occasionally, periodically, or responsively analyze the sensor data based on any suitable criteria. For example, in some embodiments, the computing device 104 may be configured to analyze the sensor data as it is received. In other embodiments, the computing device 104 may analyze the sensor data after a predefined amount of sensor data has been received, after a predefine time period has elapsed, and/or based on some other criteria. If the computing device 104 determines not to analyze the sensor data, the method 600 loops back to block 602 in which additional sensor data is received from the container sensors 110.

If, however, the computing device 104 determines that the sensor data is to be analyzed, the method 600 advances to block 614 in which the computing device 104 analyzed the sensor data received from the container sensor 110 (and any other received sensor data). In particular, in block 616, the computing device 104 analyzes the sensor data to determine a context of the reusable container 102. For example, in block 618, the computing device 104 may analyze the sensor data to determine whether the reusable container 102 is being carried (e.g., whether a carrying strap of the reusable container 102 is in a tensed state or a related state). Additionally, the computing device 104 may determine the manner in which the reusable container 102 is being carried. Such a determination may be based on, for example, the pattern of sensor data (e.g., the pattern of strain sensed by a strain gauge 120). In block 620, the computing device may determine whether the reusable container 102 is in motion and/or particular qualities of such motion such as the movement rate or gate. Again, such a determination may be based on, for example, the pattern of the sensor data. In block 622, the computing device 104 may determine the weight or presence of items held in the reusable container 102. Such a determination may be based on, for example, pressure data received from a pressure sensor 122. In block 624, the computing device 104 may determine whether the reusable container has been opened or closed. Such a determination may be based on, for example, contact sensor data from a contact sensor 124 (e.g., embedded in a latch of the reusable container 102). In block 626, the computing device 104 may determine whether an item(s) has been added to or removed from the reusable container 102. Such a determination may be based on, for example, contact sensor data from a contact sensor 124 and/or pressure data from a pressure sensor 122. In block 628, the computing device 104 may determine the signal strength, or general presence of a signal, based on the sensor data. Additionally, in block 630, the computing device 104 may determine characteristic of the environment of the reusable container 102. For example, the computing device 104 may determine the presence and/or level of certain gasses, the presence or level of light, the temperature, and/or other characteristic of the local environment of the reusable container 102.

In some embodiments, the computing device 104 may also determine or infer a context of a user of the reusable container 102 in block 632. As discussed above, the determination of the user context may be based on the currently received sensor data from the container sensor 110, on previously received sensor data from the container sensor 110, and/or on sensor data received from other sources (including sources local to and remote from the computing device 104). For example, in block 634, the computing device 104 may determine whether the user is in motion and/or qualities of such motion (e.g., walking, running, etc.) based on the sensor data. For example, the computing device 104 may determine or infer the user is walking based on the pattern of strain data generated by a strain gauge 120. Additionally, in block in block 636, the computing device 104 may determine or infer an activity performed by the user based on the sensor data received from the container sensor 110. For example, the computing device 104 may determine whether the user is carrying the reusable container 102, opening/closing the reusable container 102, placing items into or removing items form the reusable container, and/or other activities. As discussed above, the computing device 104 may also utilize other sensor data received from other sensors or sources, including sensors located on the computing device 104 or remote therefrom, to determine or infer an activity of the user. For example, the computing device 104 may determine that the user is located within a store based on data received from a location determination sensor of the computing device 104 and that the user is placing items into the reusable container 102 based on the sensor data received from the container sensor 110. As a further example, the container monitoring computing device 106, which may be embodied as a store monitoring system, may execute the method 600 to monitor the shopping habits and/or activates of shoppers. In such embodiments, the container monitoring computing device 106 may monitor the shopping activity of the user by, for example, monitoring the weight of store items placed in the reusable container 102, which may be supplied by the store. Of course, the computing device 104 and/or container monitoring computing device 106 may determine or infer other activities of the user based on the sensor data received from the container sensor 110 and/or other data in other embodiments.

As discussed above, the computing device 104 and/or container monitoring computing device 106 may include the security module 308 in some embodiments. In such embodiments, the security module 308 may monitor the sensor data received from the container sensor 110 and/or other sensor data received from other sources to determine whether a security event has occurred. As discussed above, the monitored security events may be embodied as any unauthorized interaction with the reusable container 102 based on the sensor data generated by the container sensor 110. For example, the security module 308 may monitor interactivity with the reusable container 102 and determine a security event has occurred based on such interactivity (e.g., the reusable container 102 has been opened, an item has been removed from the reusable container 102, the reusable container 102 is being moved, etc.). The presence of a security event may, of course, also be based on other data. For example, the security module 308 may determine that an opening of the reusable container 102 is authorized during certain periods of the day but unauthorized during other periods (e.g., at nighttime). As another example, the security module 308 may determine that movement of the reusable container 102 is authorized if the user (i.e., the computing device 104) is located in particular locations but is unauthorized if the user is located in other locations. Again, it should be appreciated that the security module 308 may utilize any other useful data in conjunction with the sensor data received from the container sensor(s) 110, along with other security parameters, to determine the occurrence of a security event.

After the computing device 104 (or container monitoring computing device 106) has analyzed the sensor data in block 614, the method 600 advances to blocks 640 and 642 (see FIG. 7). In block 640, the computing device 104 determines whether to store the analysis data. If so, the method advances to block 644 in which the computing device 104 stores the analysis data in a local storage. For example, the computing device 104 may store the determined context of the reusable container 102 in block 656 and/or the context of the user of the reusable container 102 in block 648. Such stored context data may subsequently be used in determining, or otherwise improving the determination of, the context of the reusable container 102 and/or the user, as well as for determining the occurrence of a security event. That is, historical context data may be used in such determinations in some embodiments. After the analysis data has been stored in block 644 or if a determination to not store the analysis data is determined in block 640, the method 600 loops back to block 602 (see FIG. 6) in which additional sensor data is received from the container sensor(s) 110.

Referring back to block 642 (see FIG. 7), the computing device 104 determines whether a security event has occurred based on the analysis performed in block 638. As discussed above, a security event may be embodied as any unauthorized interaction with the reusable container 102. If the computing device 104 determines that a security event has occurred, the method 600 advances to block 650 in which the computing device 104 responds to the security event. To do so, the computing device 104 may perform any suitable security response. For example, the computing device 104 may notify the user in block 652, transmit data related to the security event (e.g., the sensor data) in block 654, and/or activate an alarm in block 656.

For example, in embodiments in which the computing device 104 is embodied as a mobile computing device (e.g., a smartphone or tablet computer), the computing device 104 may display an alert message on a display in block 652 to notify the user of the security event. Additionally, or alternatively, the computing device 104 may transmit the security event data to another device (e.g., from the user's smartphone to the user's laptop computer) in block 654. The computing device 104 may also active an alarm on the computing device 104 or other device of the user in block 656. For example, the computing device may generate an audible or tactile alarm in block 656. Alternatively, in embodiments in which the method 600 is executed by the container monitoring computing device 106, the container monitoring computing device 106 may transmit a notification to the computing device 104 of the user of the reusable container 102 to notify the user of the security event. Additionally, the container monitoring computing device 106 may generate a local or remote alarm in block 656 in response to the security event. Regardless, after the security event has been responded to in block 650 or if no security event has occurred in block 642, the method 600 loops back to block 602 (see FIG. 6) in which additional sensor data is received from the container sensor(s) 110.

### EXAMPLES

Illustrative examples of the technologies disclosed herein are provided below. An embodiment of the technologies may include any one or more, and any combination of, the examples described below.

Example 1 includes a reusable container to hold items of a user, the reusable container comprising an openable enclosure to hold the items of the user; and a container sensor coupled to the openable enclosure, wherein the container sensor is to (i) generate sensor data indicative of a context of the reusable container and (ii) transmit the sensor data to a separate computing device.

Example 2 includes the subject matter of Example 1, and further including a carrying strap coupled to the openable enclosure and usable by a user to carry the openable enclosure, wherein the container sensor is attached to the strap.

Example 3 includes the subject matter of any of Examples 1 and 2, and wherein the container sensor is a strain-gauge.

Example 4 includes the subject matter of any of Examples 1-3, and further including a first carrying strap and a second carrying strap, each of the first and second carrying straps usable by a user to carry the openable enclosure, wherein the container sensor is a first container sensor attached to the first carrying strap, and further comprising a second container sensor attached to the second carrying strap.

Example 5 includes the subject matter of any of Examples 1-4, and further including a carrying strap and a clasp, the clasp securing the carrying strap to the openable enclosure, and wherein the container sensor is attached to the clasp.

Example 6 includes the subject matter of any of Examples 1-5, and further including a latch operable by a user to secure the openable enclosure in a closed state, and wherein the container sensor is attached to the latch.

Example 7 includes the subject matter of any of Examples 1-6, and wherein the openable enclosure comprises an enclosure wall and the container sensor is attached to the enclosure wall.

Example 8 includes the subject matter of any of Examples 1-7, and wherein the container sensor comprises a pressure sensor to generate sensor data indicative of the presence of an item held in the openable enclosure.

Example 9 includes the subject matter of any of Examples 1-8, and wherein the container sensor comprises an environmental sensor to generate sensor data indicative a characteristic of an environment of the reusable container.

Example 10 includes the subject matter of any of Examples 1-9, and wherein the container sensor comprises a signal strength sensor to generate sensor data indicative of a signal strength of a signal received by the signal strength sensor.

Example 11 includes the subject matter of any of Examples 1-10, and wherein the sensor data is indicative of whether a user is carrying the reusable container.

Example 12 includes the subject matter of any of Examples 1-11, and wherein the sensor data is indicative of whether the user is carrying the reusable container by a carrying strap of the container.

Example 13 includes the subject matter of any of Examples 1-12, and wherein the sensor data is indicative of whether the reusable container is in motion.

Example 14 includes the subject matter of any of Examples 1-13, and wherein the sensor data is indicative of whether an openable enclosure of the reusable container is open.

Example 15 includes the subject matter of any of Examples 1-14, and wherein the sensor data is indicative of a total weight of items held by the reusable container.

Example 16 includes the subject matter of any of Examples 1-15, and wherein the sensor data is indicative of whether an item has been added or removed from the reusable container.

Example 17 includes the subject matter of any of Examples 1-16, and wherein the container sensor comprises a local storage and the container sensor is to locally store the sensor data, and wherein to transmit the sensor data comprises to retrieve the sensor data from the local storage and transmit the retrieved sensor data.

Example 18 includes the subject matter of any of Examples 1-17, and wherein the container sensor comprises power generation circuitry to generate an amount of power to power the sensor container, and wherein the power generation circuitry is to store the amount of power in a power storage of the container sensor.

Example 19 includes the subject matter of any of Examples 1-18, and wherein the power generation circuitry comprises a piezoelectric power generation circuit to generate the amount of power in response to motion of the reusable container.

Example 20 includes a method for generating context data of a reusable container, the method comprising generating, by a container sensor incorporated in a portion of the reusable container, sensor data indicative of a context of the reusable container; and transmitting the sensor data to a remote computing device.

Example 21 includes the subject matter of Example 20, and wherein generating the sensor data comprises generating sensor data by a sensor attached to a carrying strap of the reusable container.

Example 22 includes the subject matter of any of Examples 20 and 21, and wherein generating the sensor data comprises generating sensor data by a strain-gauge sensor attached to the carrying strap of the reusable container.

Example 23 includes the subject matter of any of Examples 20-22, and wherein generating the sensor data comprises generating first sensor data by a first sensor attached to a first carrying strap of the reusable container and second sensor data generated by a second sensor attached to a second carrying strap of the container.

Example 24 includes the subject matter of any of Examples 20-23, and wherein generating the sensor data comprises generating sensor data by a container sensor attached to a clasp of the reusable container, wherein the clasp secures a carrying strap of the reusable container to an openable enclosure of the reusable container.

Example 25 includes the subject matter of any of Examples 20-24, and wherein generating the sensor data comprises generating the sensor data by a container sensor attached to a latch of an openable enclosure of the reusable container, the latch operable by a user to secure the openable enclosure in a closed state.

Example 26 includes the subject matter of any of Examples 20-25, and wherein generating the sensor data comprises generating the sensor data by a sensor attached to an enclosure wall of an openable enclosure of the reusable container.

Example 27 includes the subject matter of any of Examples 20-26, and wherein generating the sensor data comprises generating, by a pressure sensor, sensor data indicative of the presence of an item in the reusable container.

Example 28 includes the subject matter of any of Examples 20-27, and wherein generating the sensor data comprises generating, by an environmental sensor, sensor data indicative of a characteristic of an environment of the reusable container.

Example 29 includes the subject matter of any of Examples 20-28, and wherein generating the sensor data comprises generating, by a signal strength sensor, sensor data indicative of a signal strength of a signal received by the signal strength sensor.

Example 30 includes the subject matter of any of Examples 20-29, and wherein generating the sensor data comprises generating sensor data indicative of whether a user is carrying the reusable container.

Example 31 includes the subject matter of any of Examples 20-30, and wherein generating the sensor data comprises generating sensor data indicative of whether the user is carrying the reusable container by a carrying strap of the container.

Example 32 includes the subject matter of any of Examples 20-31, and wherein generating the sensor data comprises generating sensor data indicative of whether the reusable container is in motion.

Example 33 includes the subject matter of any of Examples 20-32, and wherein generating the sensor data comprises generating sensor data indicative of whether an openable enclosure of the reusable container is open.

Example 34 includes the subject matter of any of Examples 20-33, and wherein generating the sensor data comprises generating sensor data indicative of a total weight of items held by the reusable container.

Example 35 includes the subject matter of any of Examples 20-34, and wherein generating the sensor data comprises generating sensor data indicative of whether an item has been added or removed from the reusable container.

Example 36 includes the subject matter of any of Examples 20-35, and further including locally storing the sensor data, wherein transmitting the sensor data comprises (i) retrieving the sensor data from a storage of the container sensor and (ii) transmitting the retrieved sensor data.

Example 37 includes the subject matter of any of Examples 20-36, and further including generating, by a power generation circuitry of the container sensor, an amount of power to power the sensor container; and storing the amount of power in a power storage of the container sensor.

Example 38 includes the subject matter of any of Examples 20-37, and wherein generating the amount of power comprises generating the amount of power in response to motion of the reusable container.

Example 39 includes one or more computer-readable storage media comprising a plurality of instructions that, in response to execution, cause a container sensor to perform the method of any of Examples 20-38.

Example 40 includes a computing device for analyzing container sensor data, the computing device comprising a communication module to receive sensor data from a container sensor incorporated into a reusable container; and a sensor data analysis module to analyze the sensor data to determine a context of the reusable container.

Example 41 includes the subject matter of Example 40, and wherein the communication module is to periodically receive sensor data broadcasted by the container sensor.

Example 42 includes the subject matter of any of Examples 40 and 41, and wherein the communication module is to transmit an interrogation signal to the container sensor, and wherein to receive the sensor data comprises to receive the sensor data from the container sensor in response to the interrogation signal.

Example 43 includes the subject matter of any of Examples 40-42, and wherein analyzing the sensor data comprises analyzing the sensor data to determine whether the reusable container is being carried.

Example 44 includes the subject matter of any of Examples 40-43, and wherein the sensor data analysis module is to analyze the sensor data to determine whether the container is being carried by a carrying strap of the reusable container.

Example 45 includes the subject matter of any of Examples 40-44, and wherein the sensor data analysis module is to analyze the sensor data to determine whether the reusable container is in motion.

Example 46 includes the subject matter of any of Examples 40-45, and wherein the sensor data analysis module is to analyze the sensor data to determine whether an openable enclosure of the reusable container is open.

Example 47 includes the subject matter of any of Examples 40-46, and wherein the sensor data analysis module is to analyze the sensor data to determine a total weight of items held by the reusable container.

Example 48 includes the subject matter of any of Examples 40-47, and wherein the sensor data analysis module is to analyze the sensor data to determine whether an item has been added or removed the reusable container.

Example 49 includes the subject matter of any of Examples 40-48, and wherein analyzing the sensor data comprises analyzing the sensor data to determine a characteristic of an environment of the reusable container.

Example 50 includes the subject matter of any of Examples 40-49, and wherein the sensor data analysis module is to analyze the sensor data to determine a signal strength of a signal received by the container sensor.

Example 51 includes the subject matter of any of Examples 40-50, and wherein the sensor data analysis module is further to analyze the sensor data to determine a context of a user of the reusable container.

Example 52 includes the subject matter of any of Examples 40-51, and wherein the sensor data analysis module is to analyze the sensor data to determine whether the user is in motion.

Example 53 includes the subject matter of any of Examples 40-52, and wherein the sensor data analysis module is to analyze the sensor data to determine an activity being performed by the user.

Example 54 includes the subject matter of any of Examples 40-53, and wherein the sensor data analysis module is to analyze the sensor data to determine whether the user is shopping.

Example 55 includes the subject matter of any of Examples 40-54, and wherein the sensor data analysis module is to analyze the sensor data to track items placed in the reusable container.

Example 56 includes the subject matter of any of Examples 40-55, and further including a security module to (i) determine whether a security event has occurred based on the sensor data and (ii) respond to the security event in response to a determination that the security event has occurred.

Example 57 includes the subject matter of any of Examples 40-56, and wherein to determine whether a security event has occurred comprises to determine whether an unauthorized access of the reusable container has occurred.

Example 58 includes the subject matter of any of Examples 40-57, and wherein the security module is to determine that an openable enclosure of the reusable container has been accessed based on the sensor data; and determine a location of the user; wherein to determine whether an unauthorized access of the reusable container has occurred comprises to determine, in response to the determination that the openable enclosure has been accessed, whether the access is authorized for the determined location.

Example 59 includes the subject matter of any of Examples 40-58, and wherein the response module is to notify a user of the reusable container.

Example 60 includes the subject matter of any of Examples 40-59, and wherein the response module is to activate an alarm.

Example 61 includes the subject matter of any of Examples 40-60, and wherein the response module is to transmit security event data indicative of the security event to a mobile computing device of the user.

Example 62 includes a method for analyzing container sensor data, the method comprising receiving, by a separate computing device, sensor data from a container sensor incorporated into a reusable container; and analyzing, by the separate computing device, the sensor data to determine a context of the reusable container.

Example 63 includes the subject matter of Example 62, and wherein receiving the sensor data comprises periodically receiving sensor data broadcasted by the container sensor.

Example 64 includes the subject matter of any of Examples 62 and 63, and wherein receiving the sensor data comprises transmitting an interrogation signal to the container sensor; and receiving, from the container sensor, the sensor data in response to the interrogation signal.

Example 65 includes the subject matter of any of Examples 62-64, and wherein analyzing the sensor data comprises analyzing the sensor data to determine whether the reusable container is being carried.

Example 66 includes the subject matter of any of Examples 62-65, and wherein analyzing the sensor data comprises analyzing the sensor data to determine whether the container is being carried by a carrying strap of the reusable container.

Example 67 includes the subject matter of any of Examples 62-66, and wherein analyzing the sensor data comprises analyzing the sensor data to determine whether the reusable container is in motion.

Example 68 includes the subject matter of any of Examples 62-67, and wherein analyzing the sensor data comprises analyzing the sensor data to determine whether an openable enclosure of the reusable container is open.

Example 69 includes the subject matter of any of Examples 62-68, and wherein analyzing the sensor data comprises analyzing the sensor data to determine a total weight of items held by the reusable container.

Example 70 includes the subject matter of any of Examples 62-69, and wherein analyzing the sensor data comprises analyzing the sensor data to determine whether an item has been added or removed the reusable container.

Example 71 includes the subject matter of any of Examples 62-70, and wherein analyzing the sensor data comprises analyzing the sensor data to determine a characteristic of an environment of the reusable container.

Example 72 includes the subject matter of any of Examples 62-71, and wherein analyzing the sensor data comprises analyzing the sensor data to determine a signal strength of a signal received by the container sensor.

Example 73 includes the subject matter of any of Examples 62-72, and further including analyzing the sensor data to determine a context of a user of the reusable container.

Example 74 includes the subject matter of any of Examples 62-73, and wherein analyzing the sensor data comprises analyzing the sensor data to determine whether the user is in motion.

Example 75 includes the subject matter of any of Examples 62-74, and wherein analyzing the sensor data comprises analyzing the sensor data to determine an activity being performed by the user.

Example 76 includes the subject matter of any of Examples 62-75, and wherein analyzing the sensor data comprises analyzing the sensor data to determine whether the user is shopping.

Example 77 includes the subject matter of any of Examples 62-76, and wherein analyzing the sensor data comprises tracking items placed in the reusable container.

Example 78 includes the subject matter of any of Examples 62-77, and wherein analyzing the sensor data comprises determining whether a security event has occurred based on the sensor data, and responding to the security event in response to determining that the security event has occurred.

Example 79 includes the subject matter of any of Examples 62-78, and wherein determining whether a security event has occurred comprises determining whether an unauthorized access of the reusable container has occurred.

Example 80 includes the subject matter of any of Examples 62-79, and wherein determining whether an unauthorized access of the reusable container has occurred comprises determining that an openable enclosure of the reusable container has been accessed based on the sensor data; determining a location of the user; and determining, in response to determining that the openable enclosure has been accessed, whether the access is authorized for the determined location.

Example 81 includes the subject matter of any of Examples 62-80, and wherein responding to the security event comprises notifying a user of the reusable container.

Example 82 includes the subject matter of any of Examples 62-81, and wherein responding to the security event comprises activating an alarm.

Example 83 includes the subject matter of any of Examples 62-82, and wherein notifying the user comprises transmitting security event data indicative of the security event to a mobile computing device of the user.

Example 84 includes one or more computer-readable storage media comprising a plurality of instructions that, in response to execution, cause a computing device to perform the method of any of Examples 62-83.

Example 85 includes a reusable container comprising means for generating, by a container sensor incorporated in a portion of the reusable container, sensor data indicative of a context of the reusable container; and means for transmitting the sensor data to a remote computing device.

Example 86 includes the subject matter of Example 85, and wherein the means for generating the sensor data comprises means for generating sensor data by a sensor attached to a carrying strap of the reusable container.

Example 87 includes the subject matter of any of Examples 85 and 86, and wherein the means for generating the sensor data comprises means for generating sensor data by a strain-gauge sensor attached to the carrying strap of the reusable container.

Example 88 includes the subject matter of any of Examples 85-87, and wherein the means for generating the sensor data comprises means for generating first sensor data by a first sensor attached to a first carrying strap of the reusable container and second sensor data generated by a second sensor attached to a second carrying strap of the container.

Example 89 includes the subject matter of any of Examples 85-88, and wherein the means for generating the sensor data comprises means for generating sensor data by a container sensor attached to a clasp of the reusable container, wherein the clasp secures a carrying strap of the reusable container to an openable enclosure of the reusable container.

Example 90 includes the subject matter of any of Examples 85-89, and wherein the means for generating the sensor data comprises means for generating the sensor data by a container sensor attached to a latch of an openable enclosure of the reusable container, the latch operable by a user to secure the openable enclosure in a closed state.

Example 91 includes the subject matter of any of Examples 85-90, and wherein the means for generating the sensor data comprises means for generating the sensor data by a sensor attached to an enclosure wall of an openable enclosure of the reusable container.

Example 92 includes the subject matter of any of Examples 85-91, and wherein the means for generating the sensor data comprises means for generating sensor data indicative of the presence of an item in the reusable container.

Example 93 includes the subject matter of any of Examples 85-92, and wherein the means for generating the sensor data comprises means for generating sensor data indicative of a characteristic of an environment of the reusable container.

Example 94 includes the subject matter of any of Examples 85-93, and wherein the means for generating the sensor data comprises means for generating sensor data indicative of a signal strength of a signal received by the signal strength sensor.

Example 95 includes the subject matter of any of Examples 85-94, and wherein the means for generating the sensor data comprises means for generating sensor data indicative of whether a user is carrying the reusable container.

Example 96 includes the subject matter of any of Examples 85-95, and wherein the means for generating the sensor data comprises means for generating sensor data indicative of whether the user is carrying the reusable container by a carrying strap of the container.

Example 97 includes the subject matter of any of Examples 85-96, and wherein the means for generating the sensor data comprises means for generating sensor data indicative of whether the reusable container is in motion.

Example 98 includes the subject matter of any of Examples 85-97, and wherein the means for generating the sensor data comprises means for generating sensor data indicative of whether an openable enclosure of the reusable container is open.

Example 99 includes the subject matter of any of Examples 85-98, and wherein the means for generating the sensor data comprises means for generating sensor data indicative of a total weight of items held by the reusable container.

Example 100 includes the subject matter of any of Examples 85-99, and wherein the means for generating the sensor data comprises means for generating sensor data indicative of whether an item has been added or removed from the reusable container.

Example 101 includes the subject matter of any of Examples 85-100, and further including means for locally storing the sensor data, wherein the means for transmitting the sensor data comprises (i) means for retrieving the sensor data from a storage of the container sensor and (ii) means for transmitting the retrieved sensor data.

Example 102 includes the subject matter of any of Examples 85-101, and further including means for generating an amount of power to power the sensor container; and means for storing the amount of power in a power storage of the container sensor.

Example 103 includes the subject matter of any of Examples 85-102, and wherein the means for generating the amount of power comprises means for generating the amount of power in response to motion of the reusable container.

Example 104 includes a computing device for analyzing container sensor data, the computing device comprising means for receiving sensor data from a container sensor incorporated into a reusable container; and means for analyzing the sensor data to determine a context of the reusable container.

Example 105 includes the subject matter of Example 104, and wherein the means for receiving the sensor data comprises means for periodically receiving sensor data broadcasted by the container sensor.

Example 106 includes the subject matter of any of Examples 104 and 105, and wherein the means for receiving the sensor data comprises means for transmitting an interrogation signal to the container sensor; and means for receiving, from the container sensor, the sensor data in response to the interrogation signal.

Example 107 includes the subject matter of any of Examples 104-106, and wherein the means for analyzing the sensor data comprises means for analyzing the sensor data to determine whether the reusable container is being carried.

Example 108 includes the subject matter of any of Examples 104-107, and wherein the means for analyzing the sensor data comprises means for analyzing the sensor data to determine whether the container is being carried by a carrying strap of the reusable container.

Example 109 includes the subject matter of any of Examples 104-108, and wherein the means for analyzing the sensor data comprises means for analyzing the sensor data to determine whether the reusable container is in motion.

Example 110 includes the subject matter of any of Examples 104-109, and wherein the means for analyzing the sensor data comprises means for analyzing the sensor data to determine whether an openable enclosure of the reusable container is open.

Example 111 includes the subject matter of any of Examples 104-110, and wherein the means for analyzing the sensor data comprises means for analyzing the sensor data to determine a total weight of items held by the reusable container.

Example 112 includes the subject matter of any of Examples 104-111, and wherein the means for analyzing the sensor data comprises means for analyzing the sensor data to determine whether an item has been added or removed the reusable container.

Example 113 includes the subject matter of any of Examples 104-112, and wherein the means for analyzing the sensor data comprises means for analyzing the sensor data to determine a characteristic of an environment of the reusable container.

Example 114 includes the subject matter of any of Examples 104-113, and wherein the means for analyzing the sensor data comprises means for analyzing the sensor data to determine a signal strength of a signal received by the container sensor.

Example 115 includes the subject matter of any of Examples 104-114, and further including means for analyzing the sensor data to determine a context of a user of the reusable container.

Example 116 includes the subject matter of any of Examples 104-115, and wherein the means for analyzing the sensor data comprises means for analyzing the sensor data to determine whether the user is in motion.

Example 117 includes the subject matter of any of Examples 104-116, and wherein the means for analyzing the sensor data comprises means for analyzing the sensor data to determine an activity being performed by the user.

Example 118 includes the subject matter of any of Examples 104-117, and wherein the means for analyzing the sensor data comprises means for analyzing the sensor data to determine whether the user is shopping.

Example 119 includes the subject matter of any of Examples 104-118, and wherein the means for analyzing the sensor data comprises means for tracking items placed in the reusable container.

Example 120 includes the subject matter of any of Examples 104-119, and wherein the means for analyzing the sensor data comprises means for determining whether a security event has occurred based on the sensor data, and means for responding to the security event in response to determining that the security event has occurred.

Example 121 includes the subject matter of any of Examples 104-120, and wherein the means for determining whether a security event has occurred comprises means for determining whether an unauthorized access of the reusable container has occurred.

Example 122 includes the subject matter of any of Examples 104-121, and wherein the means for determining whether an unauthorized access of the reusable container has occurred comprises means for determining that an openable enclosure of the reusable container has been accessed based on the sensor data; means for determining a location of the user; and means for determining, in response to determining that the openable enclosure has been accessed, whether the access is authorized for the determined location.

Example 123 includes the subject matter of any of Examples 104-122, and wherein the means for responding to the security event comprises means for notifying a user of the reusable container.

Example 124 includes the subject matter of any of Examples 104-123, and wherein the means for responding to the security event comprises means for activating an alarm.

Example 125 includes the subject matter of any of Examples 104-124, and wherein the means for notifying the user comprises means for transmitting security event data indicative of the security event to a mobile computing device of the user.

1. A reusable container to hold items of a user, the reusable container comprising:
an openable enclosure to hold the items of the user; and
a container sensor coupled to the openable enclosure, wherein the container sensor is to (i) generate sensor data indicative of a context of the reusable container and (ii) transmit the sensor data to a separate computing device.

2. The reusable container of claim 1, further comprising:
a carrying strap coupled to the openable enclosure and usable by a user to carry the openable enclosure, wherein the container sensor comprises a strain-gauge attached to the strap.

3. The reusable container of claim 1, further comprising a carrying strap and a clasp, the clasp securing the carrying strap to the openable enclosure, and
wherein the container sensor is attached to the clasp.

4. The reusable container of claim 1, further comprising a latch operable by a user to secure the openable enclosure in a closed state, and
wherein the container sensor is attached to the latch.

5. The reusable container of claim 1, wherein the openable enclosure comprises an enclosure wall and the container sensor is attached to the enclosure wall.

6. The reusable container of claim 1, wherein the container sensor comprises (i) a pressure sensor to generate sensor data indicative of the presence of an item held in the openable enclosure, (ii) an environmental sensor to generate sensor data indicative a characteristic of an environment of the reusable container, or (iii) a signal strength of a signal received by the signal strength sensor.

7. The reusable container of claim 1, wherein the sensor data is indicative of at least one of (i) whether a user is carrying the reusable container, (ii) whether the user is carrying the reusable container by a carrying strap of the container, (iii) whether the reusable container is in motion, (iv) whether an openable enclosure of the reusable container is open, (v) a total weight of items held by the reusable container, or (vi) whether an item has been added or removed from the reusable container.

8. The reusable container of claim 1, wherein the container sensor comprises a local storage and the container sensor is to locally store the sensor data, and
wherein to transmit the sensor data comprises to retrieve the sensor data from the local storage and transmit the retrieved sensor data.

9. The reusable container of claim 1, wherein the container sensor comprises a piezoelectric power generation circuitry to generate the amount of power in response to motion of the reusable container.

10. A method for generating context data of a reusable container, the method comprising:
generating, by a container sensor incorporated in a portion of the reusable container, sensor data indicative of a context of the reusable container; and
transmitting the sensor data to a remote computing device.

11. The method of claim 10, wherein generating the sensor data comprises generating sensor data by at least one of: (i) a strain-gauge sensor attached to a carrying strap of the reusable container, (ii) a container sensor attached to a clasp of the reusable container, wherein the clasp secures a carrying strap of the reusable container to an openable enclosure of the reusable container, (iii) a container sensor attached to a latch of an openable enclosure of the reusable container, the latch operable by a user to secure the openable enclosure in a closed state, or (iv) a sensor attached to an enclosure wall of an openable enclosure of the reusable container.

12. The method of claim 10, wherein generating the sensor data comprises at least one of (i) generating, by a pressure sensor, sensor data indicative of the presence of an item in the reusable container, (ii) generating, by an environmental sensor, sensor data indicative of a characteristic of an environment of the reusable container, or (iii) generating, by a signal strength sensor, sensor data indicative of a signal strength of a signal received by the signal strength sensor.

13. The method of claim 10, wherein generating the sensor data comprises at least one of (i) generating sensor data indicative of whether a user is carrying the reusable container, (ii) generating sensor data indicative of whether the user is carrying the reusable container by a carrying strap of the container, (iii) generating sensor data indicative of whether the reusable container is in motion, (iv) generating sensor data indicative of whether an openable enclosure of the reusable container is open, (v) generating sensor data indicative of a total weight of items held by the reusable container, or (vi) generating sensor data indicative of whether an item has been added or removed from the reusable container.

14. The method of claim 10, further comprising locally storing the sensor data, wherein transmitting the sensor data comprises (i) retrieving the sensor data from a storage of the container sensor and (ii) transmitting the retrieved sensor data.

15. The method of claim 10, further comprising:
generating, by a power generation circuitry of the container sensor, an amount of power to power the container sensor in response to motion of the reusable container.

16. One or more computer-readable storage media comprising a plurality of instructions that, in response to execution, cause a container sensor incorporated in a portion of a reusable container to:
generate sensor data indicative of a context of the reusable container; and
transmit the sensor data to a remote computing device.

17. The computer-readable storage media of claim 16, wherein the container sensor comprises a strain-gauge sensor attached to a carrying strap of the reusable container.

18. The computer-readable storage media of claim 16, wherein the container sensor comprises a container sensor attached to a clasp of the reusable container, wherein the clasp secures a carrying strap of the reusable container to an openable enclosure of the reusable container.

19. The computer-readable storage media of claim 16, wherein the container sensor comprises a container sensor attached to a latch of an openable enclosure of the reusable container, the latch operable by a user to secure the openable enclosure in a closed state.

20. The computer-readable storage media of claim 16, wherein the container sensor comprises a container sensor attached to an enclosure wall of an openable enclosure of the reusable container.

21. The computer-readable storage media of claim 16, wherein to generate the sensor data comprises at least one of instructions (i) to generate, by a pressure sensor, sensor data indicative of the presence of an item in the reusable container, (ii) to generate, by an environmental sensor, sensor data indicative of a characteristic of an environment of the reusable container, or (iii) to generate, by a signal strength sensor, sensor data indicative of a signal strength of a signal received by the signal strength sensor.

22. The computer-readable storage media of claim 16, wherein to generate the sensor data comprises at least one of instructions (i) to generate sensor data indicative of whether a user is carrying the reusable container, (ii) to generate sensor data indicative of whether the user is carrying the reusable container by a carrying strap of the container, (iii) to generate sensor data indicative of whether the reusable container is in motion, (iv) to generate sensor data indicative of whether an openable enclosure of the reusable container is open, (v) to generate sensor data indicative of a total weight of items held by the reusable container, or (vi) to generate sensor data indicative of whether an item has been added or removed from the reusable container.

23. The computer-readable storage media of claim 16, wherein the plurality of instructions further cause the container sensor to locally store the sensor data, wherein to transmit the sensor data comprises instructions to (i) retrieve the sensor data from a storage of the container sensor and (ii) transmit the retrieved sensor data.

24. The computer-readable storage media of claim 16, wherein the plurality of instructions further cause the container sensor to generate an amount of power to power the container sensor in response to motion of the reusable container.
